(19) United States
(12) Patent Application Publication
(10) Pub. No.: US 2020/0167184 A1
(43) Pub. Date: May 28, 2020

(54) System and Method for Optimizing Placements of Virtual Machines on Hypervisor Hosts

(71) Applicant: Cirba IP Inc., Markham (CA)

(72) Inventors: Mikhail KOUZNETSOV, Maple (CA); Xuehai LU, Markham (CA); Tom YUYITUNG, Toronto (CA)

(21) Appl. No.: 16/774,193

(22) Filed: Jan. 28, 2020

Related U.S. Application Data
(63) Continuation of application No. 15/384,107, filed on Dec. 19, 2016, now abandoned.
Application No. 15/384,107 is a continuation of application No. PCT/CA2015/050575, filed on Jun. 22, 2015.
(60) Provisional application No. 62/015,183, filed on Jun. 20, 2014.

(51) Int. Cl. G06F 9/455; G06F 8/61; G06F 9/50

(52) U.S. Cl. CPC G06F 9/45558; G06F 8/61; G06F 9/5088; G06F 2009/4557; G06F 9/5055; G06F 2009/45591; G06F 9/5033

(57) ABSTRACT

A system and method are provided for determining host assignments for sub-groups of virtual machines (VMs) in a computing environment comprising a plurality of hosts, each host configured for hosting zero or more VMs. The method comprises: determining at least one sub-group of VMs from an overall set of VMs, according to at least one technical or business criterion; and determining, for each sub-group of VMs, a particular set of hosts from the plurality of hosts to be assigned to that sub-group of VMs, based on at least one of: VM-host compatibilities, and existing VM-host placements.

### CROSS-REFERENCE TO RELATED APPLICATIONS

The present application is a continuation of U.S. application Ser. No. 15/384,107 filed on Dec. 19, 2016, which is a continuation of PCT Application No. PCT/CA2015/050575 filed on Jun. 22, 2015, which claims priority to U.S. Provisional Application No. 62/015,183 filed on Jun. 20, 2014, all incorporated herein by reference

### TECHNICAL FIELD

The following relates to systems and methods for determining optimal placements of virtual machines (VMs) on hypervisor hosts; and for generating corresponding VM/host placement rules, particularly for virtual and cloud computing environments.

### DESCRIPTION OF THE RELATED ART

Virtual and cloud computing environments are comprised of one or more physical hypervisor hosts that each run zero or more VMs. These virtual environments are typically managed by a virtual machine manager (VMM) that can organize the hypervisor hosts into one or more groups (often referred to as “clusters”), for performing management functions. Many virtualization technologies allow VMs to be live migrated between hosts with no downtime. Some virtualization technologies leverage the live migration capability by automatically balancing the VM workloads across the hosts comprising a cluster on a periodic basis. Similarly, some virtualization technologies also support the ability to automatically minimize the host footprint of the running VMs to conserve power. These automated load balancing and power saving capabilities typically operate within the scope of a virtual cluster.

Such VM-to-host placements are normally subject to host level resource constraints (e.g. CPU, memory, etc.) as well as static, user-defined VM-VM affinity, VM-VM anti-affinity, VM-host affinity and VM-host anti-affinity rules. These static placement rules can be used for various purposes such as:
Running VMs belonging to a load balancing group in separate hosts for better resiliency (VM-VM anti-affinity);
Running VMs comprising an application on the same host for more efficient communication between VMs (VM affinity); and
Running VMs requiring specific software licenses on the corresponding licensed hosts (VM-host affinity).

Determining placement constraints and placement rules for a given computing environment can be time consuming, particularly when done on an ad hoc basis. It is an object of the following to address at least one of the above concerns.

### SUMMARY

In one aspect, there is provided a method of determining host assignments for sub-groups of virtual machines (VMs) in a computing environment comprising a plurality of hosts, each host configured for hosting zero or more VMs, the method comprising: determining at least one sub-group of VMs from an overall set of VMs, according to at least one technical or business criterion; and determining, for each sub-group of VMs, a particular set of hosts from the plurality of hosts to be assigned to that sub-group of VMs, based on at least one of: VM-host compatibilities, and existing VM-host placements.

In other aspects there are provided computer readable media and systems configured for performing the method.

### BRIEF DESCRIPTION OF THE DRAWINGS

Embodiments will now be described by way of example with reference to the appended drawings wherein:

FIG. 1 is a schematic diagram of an example of a virtual environment architecture;

FIG. 2 is a schematic diagram of an example of a conventional automated VM placement engine;

FIG. 3 is a schematic diagram of an example of a cluster having a mix of Windows® and Linux® VMs;

FIG. 4 is a schematic diagram of an example of a cluster that has optimized VM placements for host-based licensing;

FIG. 5 is a screen shot of a user interface providing policies for placements of VMs on hosts;

FIG. 6 is a screen shot of a user interface providing policies for VM sub-groups related to license optimization;

FIG. 7 is a flow chart illustrating computer executable instructions that can be performed to minimize host resource footprint for a VM sub-group;

FIG. 8 is a flow chart illustrating computer executable instructions that can be performed to determine optimal hosts for a VM sub-group;

FIG. 9 is a table illustrating example VM-host compatibility scores based on placement rules;

FIG. 10 is a table illustrating example VM-group-host compatibility scores based on host placement rules;

FIG. 11 is a table illustrating example VM-host compatibility scores based on current placements;

FIG. 12 is a table illustrating example group-host scores based on current placements;

FIG. 13 is a table illustrating example overall group-host compatibility scores; and

FIG. 14 is a flow chart illustrating computer executable instructions that can be performed in an ongoing management process flow.

### DETAILED DESCRIPTION

It has been found that existing technologies do not support the ability to automatically determine the placement constraints and generate the corresponding placement rules. The following provides a system and method to address this need. Common use cases for such dynamic VM-host placement constraints and rules are to:
Minimize and constrain the host-based software license usage of VMs by minimizing host resource footprint of the affected VMs. The VM-host placement constraints and rules can be dynamic due to variations in the VM utilization levels, VM resource allocations, and the number of VMs requiring the software license.
Optimize placements for VMs with complementary or conflicting historical utilization patterns by placing them on the same or different hosts. These placement rules can be dynamic as the VM workload patterns change overtime, and VMs are added or removed.

The following systems and methods are also found to be applicable to container technologies (e.g. Docker, Linux Containers) that can run multiple container workloads on container hosts. Containers and container hosts are analogous to the VMs and the hypervisor hosts. Containers also support mobility between container hosts, typically by stopping a container workload on one host, and starting a corresponding container on a different host. This technology is also applicable to routing workloads to the optimal virtual clusters while considering the compatibility and available capacity of the incoming workload and clusters.

In general, the following provides and exemplifies a model of a virtual computing environment, and provides an example of host-based licensing optimization scenario. Also provided are policies for placing VMs on hosts, and policies for optimizing VM sub-groups of an overall set of VMs in a computing environment. The system is configured to determine optimal number of hosts required per VM sub-group, determine optimal set of hosts for each VM sub-group, and deploy placement rules to enforce VM-host affinity placements. The placement affinity rules can be specified (e.g., by codifying) the relationship between the VM sub-group and the host sub-group in the VMM.

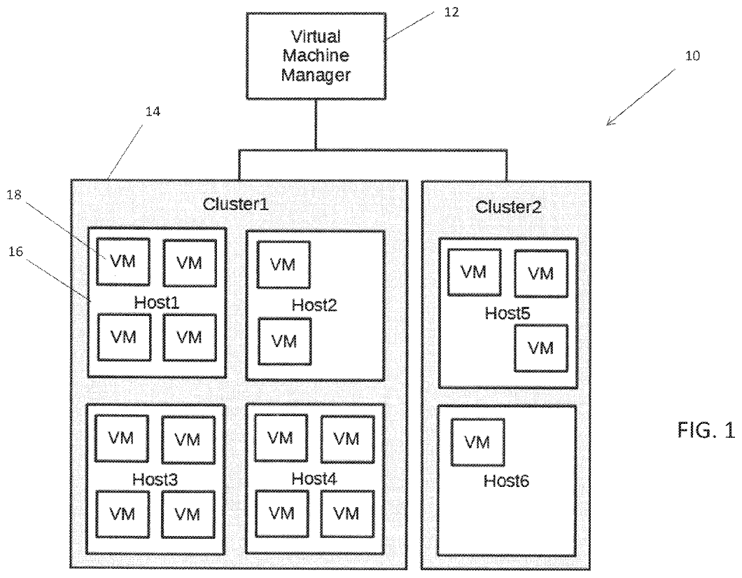

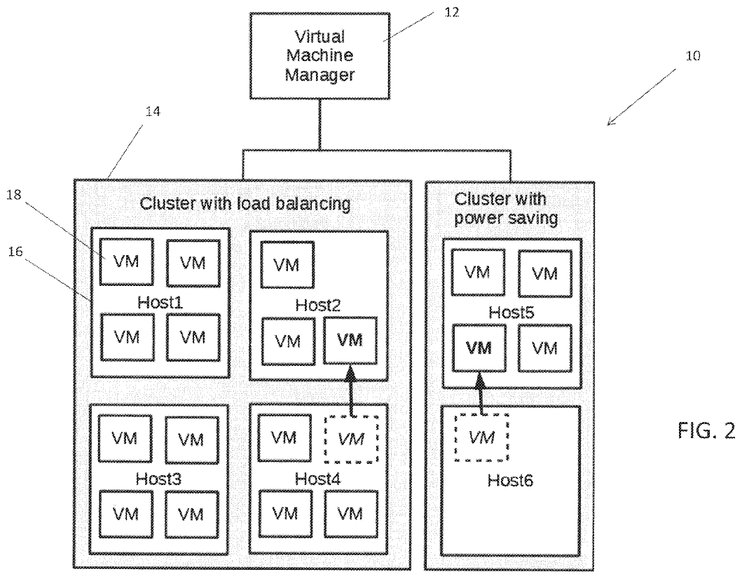

Turning now to the figures, FIG. 1 provides a model of a virtual computing environment 10 managed by a VMM 12. In this example, the environment 10 includes two clusters 14 of hosts 16. As shown in FIGS. 1 and 2, each host 16 can include zero or more VMs 18.

Data is collected from the environment 10 to determine the configuration and capacity of existing hosts 16 and of hosts 16 to be added or removed, and to determine the configuration, allocation, and utilization of existing VMs 18 and VMs 18 to be added or removed. The data collected can also be used to determine the existing VM placements, e.g., as shown schematically in FIG. 1.

FIG. 2 illustrates automated load balancing based on recent resource utilization data. This load balancing can be performed by a conventional automated VM placement engine. The placement engine is part of the VMM 12. The VMM 12 collects data from the hosts 16 regarding the host 16 and VM utilization, analyzes the data, and automatically moves VMs 18 to load balance or save power. As shown in FIG. 2, this placement engine supports VM-VM and VM-host affinity and anti-affinity placement rules. In this case, a VM 18 in Host4 is moved to Host2 to perform load balancing in Cluster1, and the only VM 18 in Host6 is moved to Host5 for power saving in Cluster2.

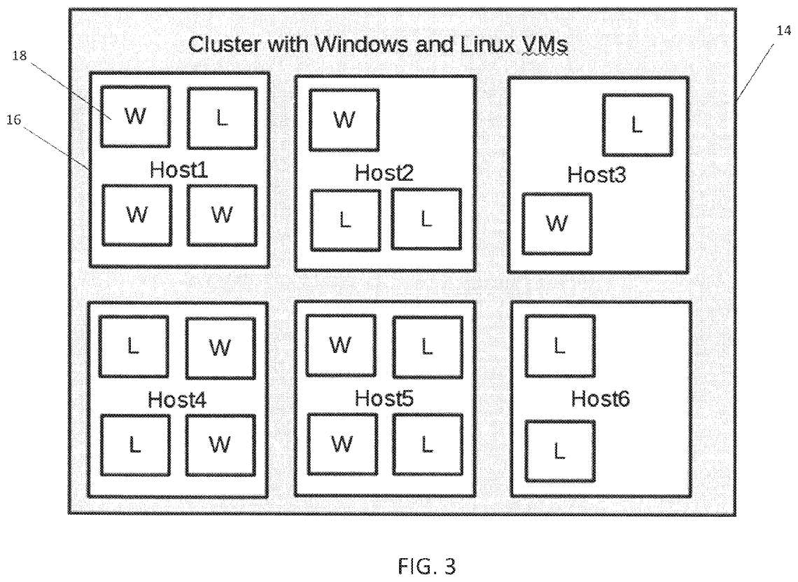

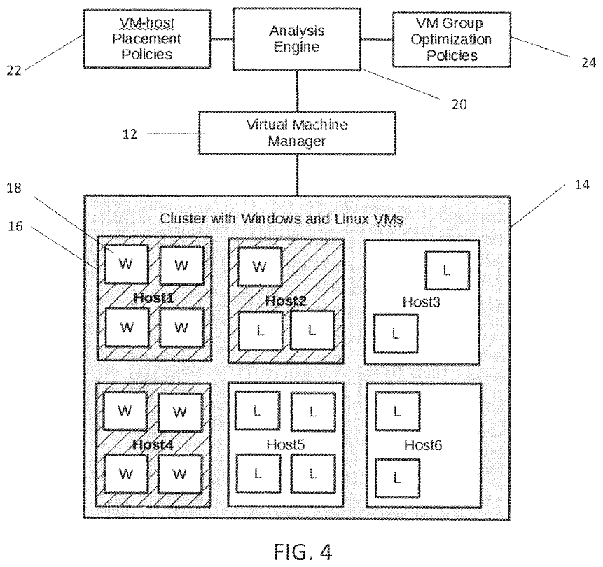

An example of a host-based licensing scenario is shown in FIGS. 3 and 4, in which a cluster 14 of six hosts 16 (Host1 through Host6) are hosting VMs 18 running Windows® (denoted W) and Linux® (denoted L) software. In many virtual clusters 14, there is a mixture of VMs 18 running different software (e.g., different operating systems, databases, applications, etc.), and licensing costs for some software used by VMs 18 are based on the amount of host resources on which the VMs 19 run.

As illustrated in FIGS. 3 and 4, reducing the host resource footprint of the selected VMs 18 can reduce software license requirements. In this example, the Windows® VMs 18 are licensed based on their host footprint. Therefore, running the Windows® VMs 18 on fewer hosts results in lower software licensing costs. In the initial placements shown in FIG. 3, the Windows® VMs 18 are running on five of the six hosts 16 and would need to be licensed for all five hosts 16. In the optimized placements shown in FIG. 4, the Windows® VMs 18 are running on three hosts and thus would only need 60% of the host-based licenses. When comparing FIGS. 3 and 4, it can be seen that in this example, the Linux® VMs 18 on Host1 and Host4 are migrated to Host3 and Host5 with the Windows® VMs 18 on Host3 and Host5 migrated to Host1and Host4.

The optimized VM placements are determined by the analysis engine 20 and are subject to the VM-host placement policies 22 that constrain the amount of resources that can be consumed by VMs on each host and the VM sub-group optimization policies 24 that dictate how to optimize the VM sub-group placements.

To determine the membership of the VM sub-groups to run on a minimum host footprint (i.e. an optimal or otherwise minimal set of hosts), VMs 18 requiring a host-based software license can be determined through discovery or imported from a configuration management database (CMDB). Also, VMs 18 in the data model are tagged based on their VM sub-group memberships, and VMs 18 can belong to one VM sub-group at a time. If VMs 18 are using more than one software license (e.g. Windows® and SQL server®), the VMs can be grouped onto multiple VM sub-groups (e.g. group with Windows® and SQL server®, and group with Windows® and no SQL server®).

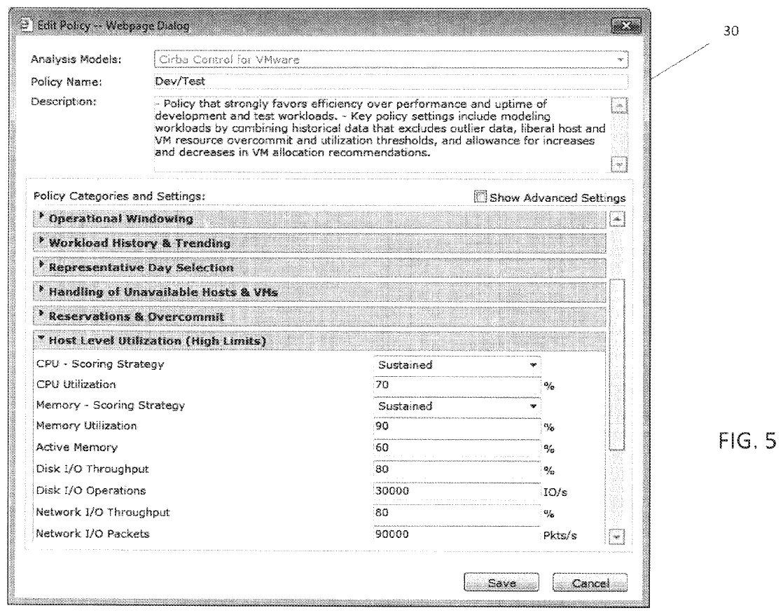

FIG. 5 illustrates a policy editing user interface 30 for policies that can be used to determine constraints for placing VMs 18 on hosts 16. The user interface 30 includes a representative workload model specification, host level resource allocation and utilization constraints (e.g., CPU, memory, disk, network I/O high limits, etc.), high availability (capacity reserved for host failures), and existing VM/host placement rules. The policies can be organized into categories as shown in FIG. 5, for example, operational windowing, workload history and trending, representative day selection, handling of unavailable hosts and VMs, reservations and overcommit, and host level utilization (i.e. high limits). The host level utilization policies are illustrated by way of example only in FIG. 5 and enables settings to be modified. For example the high limit for host CPU utilization can be specified to constrain the maximum CPU that can be used by the VMs on each host.

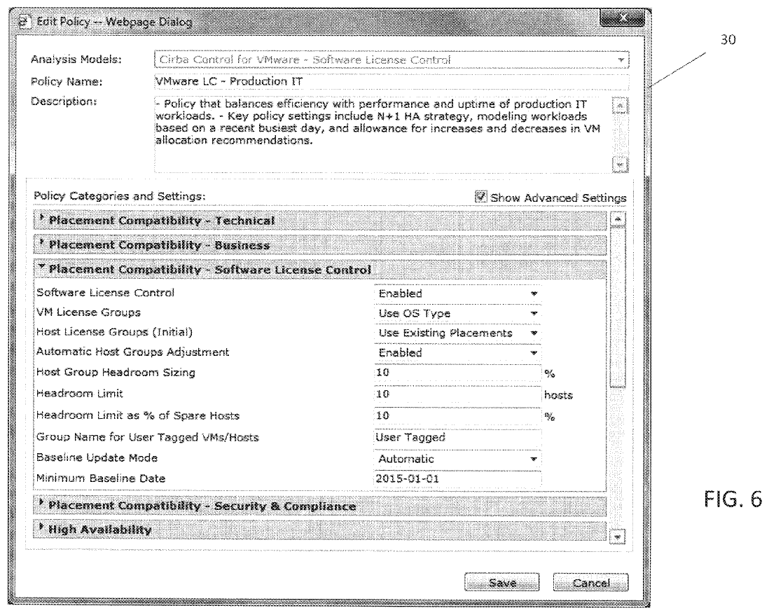

FIG. 6 illustrates the user interface 30 to manage policies for minimizing the host footprint of a group of VMs comprising a VM license group. In this scenario, the policy settings include “Software License Control” to enable or disable the license control capability and “VM License Groups” to indicate how the VMs comprising the license groups are to be determined. The settings Host Group Headroom Sizing, Headroom Limit and Headroom Limit as % of Spare Hosts are used to determine the minimum number of hosts 16. The policies can also include a setting to define the weighting factor used when choosing hosts 16 for a VM sub-group of the overall set of VMs, based the current VM placements vs. VM-host compatibility rules.

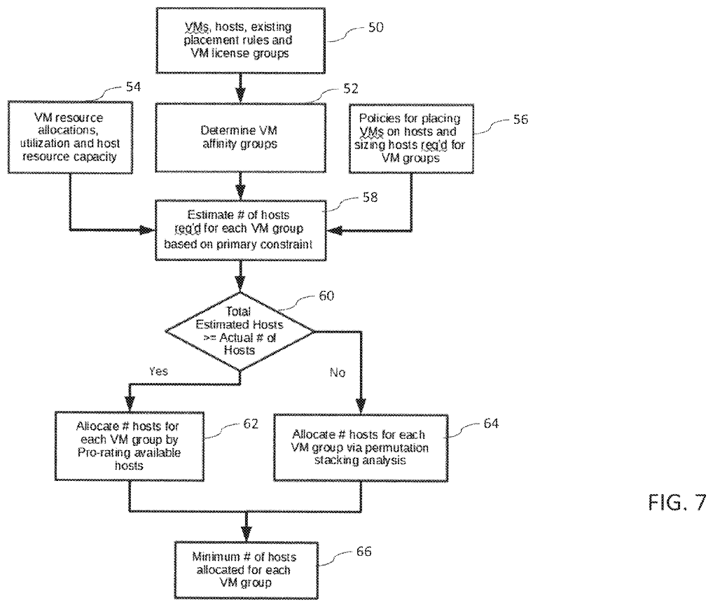

FIG. 7 provides a flow chart illustrating an example process for computing an optimal number of hosts 16 for each VM sub-group. Based on the VMs 18, hosts 16, existing placement rules, and VM license groups (50), the process begins by determining VM affinity groups (52). Using the VM affinity groups determined at 52, VM resource allocations, utilization and host resource capacity (54), policies for placing VMs 18 on hosts 16, and sizing hosts required for the VM sub-groups (56), the number of hosts 16 required for each VM sub-group is estimated at 58 based on the primary constraint.

The primary constraint is determined for each VM sub-group by computing the minimum number of hosts required to run the VMs based on each resource constraint being modeled (e.g. CPU overcommit, memory allocation, CPU utilization, memory utilization, etc.). For each resource constraint, the total resource allocations (e.g. virtual CPUs, memory allocations) or total resource utilization (CPU used, memory used, disk I/O activity, network activity) of the VMs in the VM sub-group is computed and compared against the corresponding useable resource capacity of the hosts. The useable host capacity is based on the actual host capacity and the corresponding resource limit specified through the policies. For example, the total CPU allocation for a VM sub-group is the sum of the virtual CPU allocations of the VMs. The useable CPU allocation capacity for a host is the number of CPUs of the host multiplied by the host CPU allocation limit. Similar calculations are performed for other potential resource constraints, the resource constraint that requires the most number of hosts for the VM sub-group is considered to be the primary constraint. If more than one resource constraint requires the same number of hosts, the primary constraint may be determined by considering the fractional hosts required (e.g. if CPU allocation requires 1.5 hosts and memory allocation requires 1.6 hosts, CPU allocation is considered to be the primary constraint).

If the total estimated number of hosts 16 required for all the VM sub-groups exceeds the actual number of hosts 16 (determined at 60), the fair share rule can be used to allocate the number of hosts 16 per VM sub-group, i.e. by allocating the number of hosts for each VM sub-group by pro-rating the available hosts (62).

However, if the estimated number of hosts 16 required is less than the actual number of hosts 16 (as determined at 60), the number of hosts for each VM sub-group is allocated via a permutation stacking analysis (64). The permutation stacking analysis can be performed by first sorting the VM sub-groups from largest to smallest based on the primary constraint. Then, for each group, the permutation analysis is performed by stacking the VMs 18 on the hosts 16 to ensure that the VMs 18 fit. This analysis may find that more hosts 16 are required.

The hosts are then assigned to the determined groups as required to output minimum number of host allocations for each VM sub-group (66).

To illustrate the process flow in FIG. 7, consider an example in which:
a virtual cluster is comprised of 20 VMs and 6 hosts; and
3 VM sub-groups are clustered as: G1, G2, G3.

Based on primary resource constraints (e.g. memory), the estimated number of hosts for G1, G2 and G3 are 4, 3, 2, and thus the total number of estimated hosts=9. It may be noted that each group can have different primary constraints.

In this example, the total estimated # hosts=9>actual # hosts=6.

In applying fair share, the # of hosts are allocated to the groups as follows:
G(n)=estimated # hosts required for group*actual # hosts/total estimated # hosts required. In this example scenario:

G1=4*6/9=2.67;

G2=3*6/9=2; and

G3=2*6/9=1.33.

To allocate hosts, a floor value for each group is determined as follows:

G1=2;

G2=2; and

G3=1.

Next, the sum of allocated hosts is computed, and is =5, so one host is available. The available host to group with the largest remainder (i.e. G1 with 0.67 in this example) is allocated, and the final host allocation is:

G1=3;

G2=2;

G3=1.

The optimal hosts 16 for the VM sub-groups are also determined. This process chooses the best hosts 16 for each VM sub-group, accounts for existing VM-host affinity and VM-host anti-affinity rules, and can favor current placements to minimize volatility in implementing the placement plan, and assigns hosts 16 to a host group associated with a VM-host affinity placement rule.

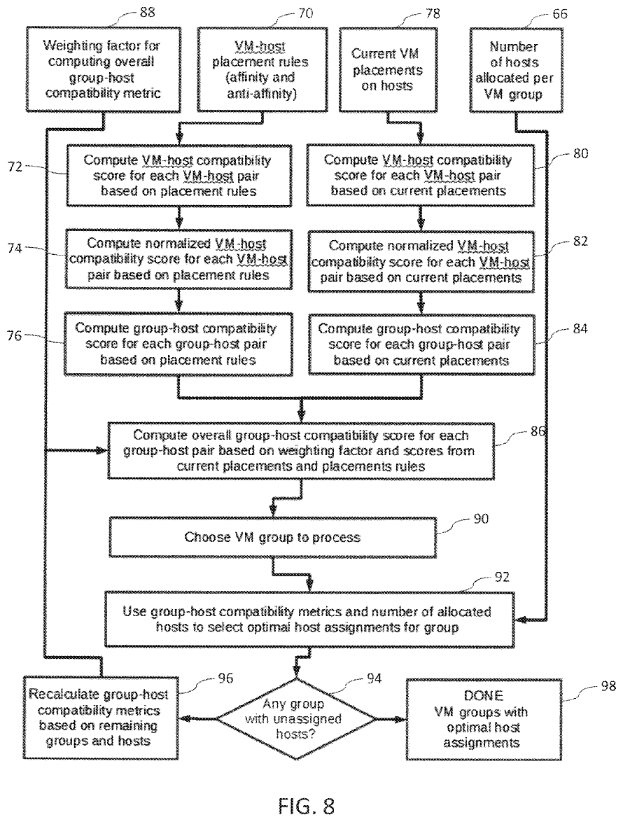

FIG. 8 illustrates a process flow for determining such optimal hosts 16 from the VM sub-groups.

Using VM-host placement rules for affinity and anti-affinity (70), a VM-host compatibility score is computed (72) for each VM-host pair based on the placement rules. A normalized VM-host compatibility score is computed (74) for each VM-host pair based on the placement rules, and a VM-group-host compatibility score is computed (76) for each group-host pair based on the placement rules.

Using the current VM placements on the hosts 16 (78), a VM-host compatibility score is computed (80) for each VM-host pair based on the current placements. A normalized VM-host compatibility score is computed (82) for each VM-host pair based on the current placements, and a group-host compatibility score is computed (84) for each group-host pair based on the current placements.

The group-host compatibility scores based on the placement rules and the current placements are then used to compute an overall group-host compatibility score (86) for each group-host pair, based on a weighting factor (88) and such scores (76, 84) from the current placements and placement rules.

From the overall group-host compatibility scores (86), a VM sub-group is chosen to process (90). The group-host compatibility metrics and the number of allocated hosts are used to select the optimal host assignments for the group (92). This is done by comparing group-host scores to choose the most suitable hosts for a group of VMs 18. For example, the largest group may be chosen first.

After assigning hosts to a VM sub-group, the process then determines if any group exists with unassigned hosts (94). In this way, the process re-computes group-host compatibility scores (96) based on the remaining groups and hosts until there are no additional unassigned hosts and the process is done. The output is a set of one or more VM sub-groups with optimal host assignments (98).

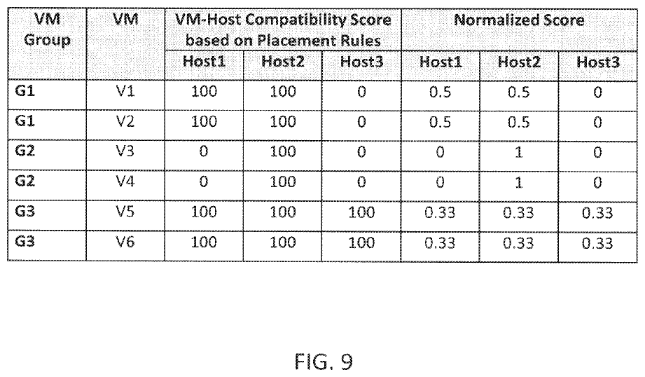

An example will now be provided, making reference to the tables shown in FIGS. 9 through 13. In FIG. 9, VM host compatibility scores based on existing placement rules are shown. In this example, VM-host compatibility scores are between 0 and 100, wherein 100 means fully compatible and 0 means incompatible.

The VM-host compatibility scores may also be based on the current VM placements on the hosts. For the current placements, the VM-host compatibility of 100 indicates that the VM is currently placed on the given host and 0 indicates VM is not placed on the given host.

When computing the compatibility scores, as shown by way of example below, when there is not full compatibility (with a score of 100) or complete incompatibility (with a score of zero), any one of a variety of scoring mechanisms can be used to assign a score between zero and 100 for partial compatibility.

For a given VM-host pair, the normalized score is compute as follows:

Normalized score for V(n)−Host(n)=compatibility score of V(n)−Host(n)/sum of scores of V(n)−Host(i=1 to h). For example, the normalized score for V1−Host1=100/(100+0+100)=0.5.

In the example shown in FIG. 9, it can be seen that based on the placement rules, V1-V4 cannot be placed on Host3, and V3 and V4 cannot be placed on Host1. Since V3 and V4 can only be placed on Host2, the normalized compatibility scores are 1 for both those cases. The normalization of the scores for V1, V2, V5 and V6 are also apparent from FIG. 9 based on which of the VMs 18 are compatible with which of the hosts 16.

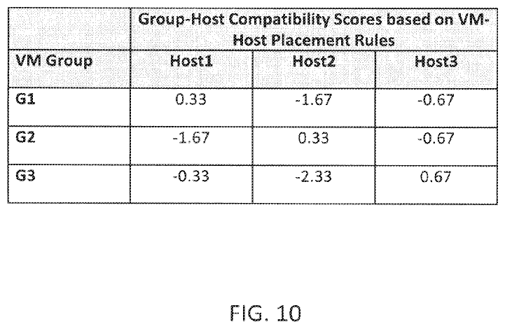

Turning now to FIG. 10, the group-host compatibility scores for this example are shown. The group-host compatibility score is a relative measure of the compatibility of the group against the target host 16, wherein the larger the value, the more compatible they are. It may be noted that the group-host compatibility score value can be negative. For a given VM sub-group and host 16, the group-host compatibility score is based on the following formula:

SUM(Normalized VM-host scores of current group)−SUM(Normalized VM-host scores of other groups); and

Compatibility score for G1−Host1=(NS(V1)+(V2))−(NS(V3)+NS(V4)+NS(V5)+NS(V6)).

In this example, the compatibility score for G1−Host1=(0.5+0.5)−(0+0+0.33+0.33)=0.33.

These group-host scores provide a relative measure for selecting optimal hosts for VM sub-groups to maximize the overall compatibility for all the groups across the available hosts. That is, the group-host scores consider not only the compatibility of that group with that host, but also how compatible other groups are with that host to optimize assignments across the board.

In the example shown in FIG. 10, VM sub-group G1 is most compatible with Host1, G2 with Host2 and G3 with Host3.

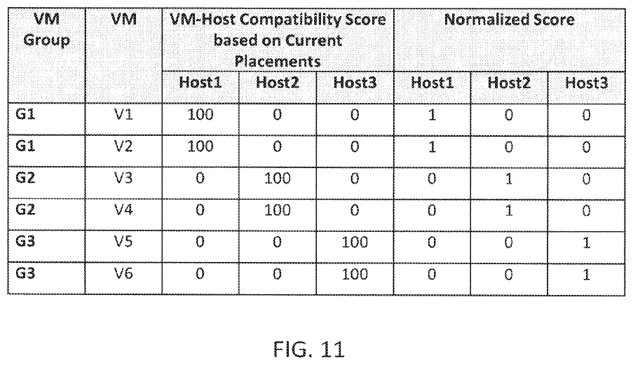

FIG. 11 illustrates the VM host compatibility scores based on the current placements, in this example. For the current placements, 100 is a current VM placement and 0 indicates that the VM 18 is not placed on a host 16. It can be seen that the 100s simply indicate on which hosts the groups are currently placed (i.e. G1 on Host1, G2 on Host2, and G3 on Host3).

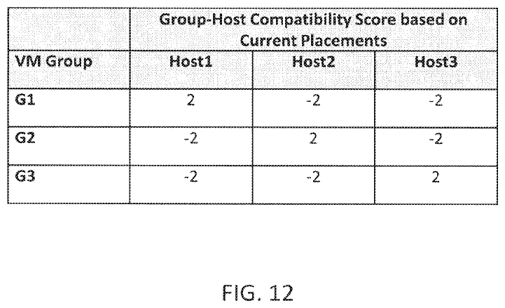

The group-host compatibility scores based on the current placements are shown in FIG. 12. These group-host compatibility scores based current placements are computed in the same way as the scores based on the existing placement rules (FIG. 10).

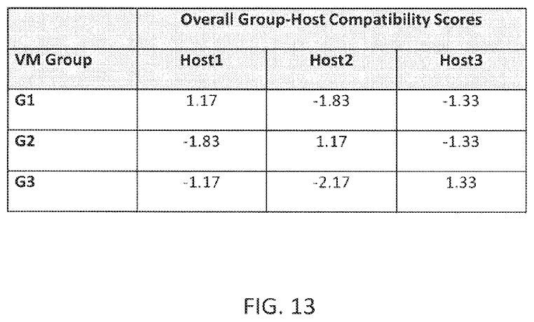

The overall group-host compatibility scores for this example are shown in FIG. 13. For each group-host, the compatibility scores from compatibility rules and current placements are blended using the weighting factor, wherein the rules weight is between 0 and 1, and the current placements weight is (1−rules weight).

The overall score is then computed as:

Overall score=current placement weight*current placement compatibility score+rules weight*rules compatibility score.

In the example scores shown in FIG. 13, rules and current placement weights of 0.5 are used and, for each group, hosts are selected based on the highest group-host compatibility scores. Based on the analysis, G1 should be placed on Host1, G2 placed on Host2, and G3 placed on Host3.

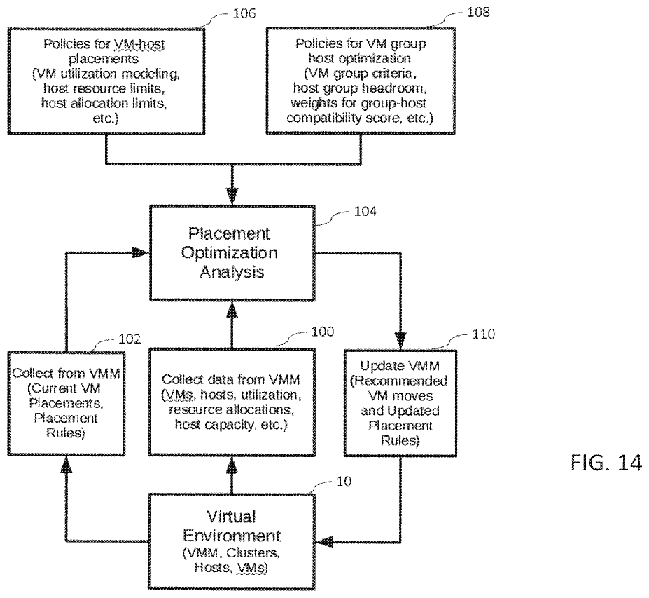

FIG. 14 illustrates a process for ongoing management of the dynamic placement rules. Data is collected from the virtual environment 10 (100), including current VM placements and rules (102). The virtual environment 10 is analyzed to determine the optimal VM-host placements (104) and corresponding VM group-host placement rules based on: policies for VM host placements (106), and policies for optimizing placements (108).

New VM placement rules are deployed for VM-host group placement optimization in order to: replace existing dynamic rules, and optionally move VMs 18 to the optimal hosts 16. The environment 10 can be re-analyzed periodically and placement rules can be replaced as needed (110).

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the any component described herein or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A computer-implemented method of configuring host in a computing environment comprising a plurality of hosts, wherein each host is configured for hosting zero or more virtual machines (VMs), the method comprising:
determining at least one sub-group of VMs from an overall set of VMs associated with the computing environment, each sub-group of VMs corresponding to VMs that have similar hosting requirements;
determining, for each sub-group of VMs, an optimal set of hosts from the plurality of hosts to be assigned to that sub-group of VMs, by applying an optimization analysis based on at least one of: VM resource allocations, VM utilization, host resource capacity, VM-host compatibilities, technical constraints, business constraints, and existing VM-host placements; and
based on the determined set of hosts, configuring host groupings in an underlying hypervisor technology in order to enable the underlying technology to enforce VM-to-host relationships as it places and periodically balances VMs.

2. The method of claim 1, further comprising specifying a relationship between each of the sub-groups of VMs and the corresponding optimal set of hosts in an underlying virtual machine manager as one or more placement affinity rules.

3. The method of claim 1, further comprising determining, for each sub-group of VMs, a minimum number of hosts required to run that sub-group of VMs.

4. The method of claim 3, wherein if the minimum number of hosts required to accommodate all sub-groups of VMs is greater than the total number of hosts, then the number of hosts in each set of hosts is determined by pro-rating available hosts.

5. The method of claim 4, wherein the pro-rating the available hosts is performed according to an estimated number of hosts based on a primary constraint.

6. The method of claim 3, wherein the minimum number of hosts required for each sub-group of VMs is determined by:
determining if an estimated number of hosts is greater than or equal to an actual number of hosts;
allocating a number of hosts for each sub-group of VMs by pro-rating available hosts when the number of estimated hosts is greater than or equal to the actual number of hosts; and
allocating the number of hosts for each sub-group of VMs by performing the optimization analysis when the number of estimated hosts is less than the number of actual hosts.

7. The method of claim 1, wherein optimal VM-host assignments are determined by:
computing an overall compatibility score for each VM-host pair using a first set of scores for each VM-host pair computed based on at least one placement rule, a second set of scores for each VM-host pair computed based on current placements of the VMs, and a weighting factor;
selecting a first sub-group of VMs;
selecting optimal host assignments for the first sub-group of VMs using at least one VM-host compatibility metric and a number of hosts allocated for the first sub-group of VMs;
for each additional sub-group of VMs, re-computing the overall compatibility score, and selecting optimal host assignments for remaining sub-groups of VMs and hosts; and
outputting the optimal host assignments for each sub-group of VMs.

8. The method of claim 7, wherein the first set of scores is computed using a third set of compatibility scores for each VM-host pair based on the at least one placement rule.

9. The method of claim 8, wherein the third set of scores is a normalized set of VM-host compatibility scores computed using the at least one placement rule.

10. The method of claim 7, wherein the second set of scores is computed using a fourth set of compatibility scores for each VM-host pair based on the current placements.

11. The method of claim 10, wherein the fourth set of scores is a normalized set of VM-host compatibility scores computed using the current placements.

12. The method of claim 5, wherein the estimated number of hosts required for each sub-group of VMs is determined using any one or more of: VM affinity groups determined using the VMs, the hosts, the placement rules, and VM license groups.

13. The method of claim 5, wherein the estimated number of hosts required for each sub-group of VMs is determined using any one or more of: policies for placing VMs on hosts, and sizing hosts required for the sub-groups.

14. The method of claim 1, further comprising obtaining data from the computing environment, and repeating the method to determine if the VM-host assignments should be updated.

15. The method of claim 1, wherein current VM placements and placement rules, and the data are obtained from a virtual machine manager (VMM) associated with the underlying hypervisor technology in the computing environment.

16. The method of claim 15, further comprising updating the VMM after repeating the method.

17. The method of claim 1, wherein the VM-host assignments consider at least one policy.

18. The method of claim 17, wherein the at least one policy comprises a license optimization policy.

19. A non-transitory computer readable medium comprising computer executable instructions for configuring host sub-groups in a computing environment comprising a plurality of hosts, wherein each host is configured for hosting zero or more virtual machines (VMs), comprising instructions for:
determining at least one sub-group of VMs from an overall set of VMs associated with the computing environment, each sub-group of VMs corresponding to VMs that have similar hosting requirements;
determining, for each sub-group of VMs, an optimal set of hosts from the plurality of hosts to be assigned to that sub-group of VMs, by applying an optimization analysis based on at least one of: VM resource allocations, VM utilization, host resource capacity, VM-host compatibilities, technical constraints, business constraints, and existing VM-host placements; and
based on the determined set of hosts, configuring host groupings in an underlying hypervisor technology in order to enable the underlying technology to enforce VM-to-host relationships as it places and periodically balances VMs.

20. A system for configuring host sub-groups in a computing environment comprising a plurality of hosts, wherein each host is configured for hosting zero or more virtual machines (VMs), the system comprising:
a processor; and
memory, the memory comprising computer executable instructions for:
determining at least one sub-group of VMs from an overall set of VMs associated with the computing environment, each sub-group of VMs corresponding to VMs that have similar hosting requirements;
determining, for each sub-group of VMs, an optimal set of hosts from the plurality of hosts to be assigned to that sub-group of VMs, by applying an optimization analysis based on at least one of: VM resource allocations, VM utilization, host resource capacity, VM-host compatibilities, technical constraints, business constraints, and existing VM-host placements; and
based on the determined set of hosts, configuring host groupings in an underlying hypervisor technology in order to enable the underlying technology to enforce VM-to-host relationships as it places and periodically balances VMs.

21. The method of claim 2, further comprising deploying the one or more placement affinity rules to enforce VM-host affinity placements in the computing environment.

22. The method of claim 1, wherein the similar hosting requirement is based on a software licensing requirement.

23. The system of claim 20, further comprising instructions for specifying a relationship between each of the sub-groups of VMs and the corresponding optimal set of hosts in an underlying virtual machine manager as one or more placement affinity rules.

24. The system of claim 21, further comprising instructions for determining, for each sub-group of VMs, a minimum number of hosts required to run that sub-group of VMs.

25. The system of claim 24, wherein if the minimum number of hosts required to accommodate all sub-groups of VMs is greater than the total number of hosts, then the number of hosts in each set of hosts is determined by pro-rating available hosts.

26. The system of claim 25, wherein the pro-rating the available hosts is performed according to an estimated number of hosts based on a primary constraint.

27. The system of claim 24, wherein the minimum number of hosts required for each sub-group of VMs is determined by:
determining if an estimated number of hosts is greater than or equal to an actual number of hosts;
allocating a number of hosts for each sub-group of VMs by pro-rating available hosts when the number of estimated hosts is greater than or equal to the actual number of hosts; and
allocating the number of hosts for each sub-group of VMs by performing the optimization analysis when the number of estimated hosts is less than the number of actual hosts.

28. The system of claim 20, wherein optimal VM-host assignments are determined by:
computing an overall compatibility score for each VM-host pair using a first set of scores for each VM-host pair computed based on at least one placement rule, a second set of scores for each VM-host pair computed based on current placements of the VMs, and a weighting factor;
selecting a first sub-group of VMs;
selecting optimal host assignments for the first sub-group of VMs using at least one VM-host compatibility metric and a number of hosts allocated for the first sub-group of VMs;
for each additional sub-group of VMs, re-computing the overall compatibility score, and selecting optimal host assignments for remaining sub-groups of VMs and hosts; and
outputting the optimal host assignments for each sub-group of VMs.

29. The system of claim 28, wherein the first set of scores is computed using a third set of compatibility scores for each VM-host pair based on the at least one placement rule.

30. The system of claim 29, wherein the third set of scores is a normalized set of VM-host compatibility scores computed using the at least one placement rule.

31. The system of claim 28, wherein the second set of scores is computed using a fourth set of compatibility scores for each VM-host pair based on the current placements.

32. The system of claim 31, wherein the fourth set of scores is a normalized set of VM-host compatibility scores computed using the current placements.

33. The system of claim 26, wherein the estimated number of hosts required for each sub-group of VMs is determined using any one or more of: VM affinity groups determined using the VMs, the hosts, the placement rules, and VM license groups.

34. The system of claim 26, wherein the estimated number of hosts required for each sub-group of VMs is determined using any one or more of: policies for placing VMs on hosts, and sizing hosts required for the sub-groups.

35. The system of claim 20, further comprising instructions for obtaining data from the computing environment, and repeating the method to determine if the VM-host assignments should be updated.

36. The system of claim 20, wherein current VM placements and placement rules, and the data are obtained from a virtual machine manager (VMM) associated with the underlying hypervisor technology in the computing environment.

37. The system of claim 36, further comprising instructions for updating the VMM after repeating the method.

38. The system of claim 20, wherein the VM-host assignments consider at least one policy.

39. The system of claim 38, wherein the at least one policy comprises a license optimization policy.

40. The system of claim 23, further comprising instructions for deploying the one or more placement affinity rules to enforce VM-host affinity placements in the computing environment.

41. The system of claim 20, wherein the similar hosting requirement is based on a software licensing requirement.
